(19) United States
(12) Patent Application Publication
(10) Pub. No.: US 2012/0099220 A1
(43) Pub. Date: Apr. 26, 2012

(54) PERPENDICULAR MAGNETIC RECORDING MEDIUM (PMRM) AND SYSTEMS THEREOF

(75) Inventors: Ichiro Tamai, Odawara (JP); Yotsuo Yahisa, Odawara (JP); Akemi Hirotsune, Odawara (JP)

(73) Assignee: Hitachi Global Storage Technologies Netherlands B. V., Amsterdam (NL)

(21) Appl. No.: 12/909,783

(22) Filed: Oct. 21, 2010

(51) Int. Cl. G11B 21/02; B05D 5/12; G11B 5/706

(52) U.S. Cl. 360/75; 428/846.2; 428/826; 427/131; G9B/21.003

(57) ABSTRACT

In one embodiment, a perpendicular magnetic recording medium includes a crystalline seed layer having a pseudo-hcp structure with stacking faults formed above a soft magnetic underlayer, a first interlayer comprising Ru and one of W, Ta, Mo, and Nb formed above the crystalline seed layer, a second interlayer formed above the first interlayer, and a magnetic recording layer formed above the second interlayer. The first interlayer has a W concentration between about 32 at % and 50 at %, Mo in a concentration between about 36 at % and 52 at %, Ta in a concentration between about 20 at % and 30 at %, or Nb in a concentration between about 7 at % and 30 at %. In another embodiment, a system includes a recording medium as described above, a magnetic head for reading from and/or writing to the medium, a head slider for supporting the head, and a control unit coupled to the head.

### FIELD OF THE INVENTION

The present invention relates to data storage systems, and more particularly, this invention relates to a perpendicular magnetic recording medium (PMRM) which allows a large volume of information to be recorded.

### BACKGROUND OF THE INVENTION

The heart of a computer is a magnetic disk drive, typically made of a magnetic recording medium composed of crystal grains, which form into groups called clusters. Storage capacity is determined by the composition and structure of the magnetic recording medium, which should robustly tolerate heat and interference from external magnetic fields, while minimizing medium noise, such that it provides a good medium upon which to write data.

In perpendicular magnetic recording systems, adjacent magnetizations do not oppose each other, and there is therefore little influence from demagnetizing fields in high-density recording regions, and such systems are suited to high-density recording. Perpendicular magnetic recording media generally have a laminated structure comprising a soft underlayer, a seed layer, an interlayer, and a magnetic recording layer. The soft magnetic layer makes it possible to increase the recording and reproduction efficiency in the perpendicular direction in combination with a single pole head. The seed layer serves to enhance the crystal orientation of the interlayer and recording layer, and to control the crystal grain size. The interlayer serves to enhance the crystal orientation of the recording layer, and to promote magnetic isolation of crystal grains in the recording layer. The recording layer is generally a granular recording layer in which an oxide is added to a CoCrPt alloy.

Current approaches for optimizing performance generally involve either refining the size of crystal grains by adding non-magnetic material to the grain boundary of a recording layer, or reducing the thickness of a seed layer and an interlayer, thereby reducing the distance between a magnetic head and a soft magnetic underlayer.

In cases where non-magnetic elements are added to the grain boundary of a recording layer, large amounts of non-magnetic elements are contained within the magnetic crystal grains, and the magnetic anisotropy energy drops, leading to problems, including signal stability deterioration. On the other hand, the oxide and magnetic crystal grains do not readily separate in granular recording layers, and therefore there is no need to add large quantities of non-magnetic elements, and it is possible to reduce noise while maintaining high magnetic anisotropy energy. Investigations have been carried out into enhancing the performance of media by improvements to the recording layer, as presented in Japanese Patent Appl. Pub. Nos. 2003-178413 and 2004-310910, for example.

When a granular recording layer of this kind is used, the crystal grain size and magnetic cluster size in the recording layer are controlled by the interlayer, and therefore the seed layer and the interlayer play an important role. In particular, the smaller the distance between the magnetic head and the soft magnetic underlayer, the sharper the recording field gradient which is obtained. Therefore, it is important to refine the crystal grains and reduce the magnetic cluster size in order to enhance the crystal orientation of the recording layer using a thin interlayer and seed layer.

U.S. Pat. No. 7,235,314, Japanese Patent Appl. Pub. Nos. 2001-283428 and 2009-134797, and IEEE Transactions Magnetics, Vol. 43, No. 2, February 2007, for example, disclose adding an element such as Cr to Ru. The aim disclosed in these references is to enhance crystal orientation and reduce lattice mismatch between the recording layer and the Ru which is used as an interlayer of the granular recording layer. However, research has shown that the reason for obtaining a high coercive force and a high medium signal-to-noise ratio (SNR) as in U.S. Pat. No. 7,235,314 is due to increasing the size of the magnetic crystal grains or the magnetic cluster size, and this interlayer cannot be said to be suitable for refining the grain size with a view to achieving a high surface recording density. Therefore, a method and/or system of overcoming the current limitations of reducing magnetic cluster size for use in recording and reproducing data with magnetic media would be very beneficial.

### SUMMARY OF THE INVENTION

In one embodiment, a perpendicular magnetic recording medium includes a crystalline seed layer having a pseudo-hcp structure with stacking faults formed above a soft magnetic underlayer, a first interlayer comprising a Ru alloy formed above the crystalline seed layer, and a magnetic recording layer formed above the first interlayer, wherein the crystalline seed layer and the first interlayer act together to create an average magnetic cluster size of the magnetic recording layer of less than about 7 nm.

In another embodiment, a system includes a perpendicular magnetic recording medium as described above, at least one magnetic head for reading from and/or writing to the magnetic recording medium, a magnetic head slider for supporting the magnetic head, and a control unit coupled to the magnetic head for controlling operation of the magnetic head.

In yet another embodiment, a method for forming a perpendicular magnetic recording medium includes forming a crystalline seed layer above a substrate, the crystalline seed layer comprising elements having a face-centered cubic (fcc) structure and elements having a body-centered cubic (bcc) structure, forming an interlayer above the crystalline seed layer, the interlayer comprising a second interlayer formed above a first interlayer, and forming a magnetic recording layer above the interlayer, wherein the first interlayer comprises Ru and at least one element selected from a group consisting of W, Mo, Ta, and Nb.

Any of these embodiments may be implemented in a magnetic data storage system such as a disk drive system, which may include a magnetic head, a drive mechanism for passing a magnetic medium (e.g., hard disk) over the magnetic head, and a controller electrically coupled to the magnetic head.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a cross-sectional view of a perpendicular magnetic recording medium (PMRM), according to one embodiment.

FIG. 2 is a plot showing the relationship between the crystallite size and the concentration of tungsten (W) in the first interlayer, according to one embodiment.

FIG. 3 is a plot showing the X-ray diffraction profiles of samples in which the seed layer is changed, according to one embodiment.

FIG. 4 is a plot showing the relationship between elements added to the first interlayer and resulting crystallite size, according to one embodiment.

FIG. 5A is a cross-sectional schematic showing a magnetic storage apparatus from a top view, according to one embodiment.

FIG. 5B is a cross-sectional schematic showing a magnetic storage apparatus from a side view, according to one embodiment.

FIG. 6 is a schematic showing the relationship between the magnetic head and the magnetic recording medium, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of disk-based storage systems and/or related systems and methods, as well as operation and/or component parts thereof.

In order to improve the recording density using a granular recording layer, the crystal grains may be refined and magnetic isolation of the crystal grains may be promoted, while maintaining the crystal orientation in the recording layer. It is possible to refine the crystal grains by making the seed layer and interlayer thinner, in some approaches. However, this method creates problems in that the crystal orientation deteriorates and the grain size distribution increases. There are further problems in that the magnetic isolation of the crystal grains is inadequate, so the noise increases. Therefore, improvements in the recording density using a granular recording layer is needed without thinning of the seed layer and the interlayer.

In one embodiment, a perpendicular magnetic recording medium employs a granular recording layer. The perpendicular magnetic recording medium enables high-density recording, the grains are refined while the crystal orientation is maintained, and noise is reduced. In another embodiment, a magnetic storage apparatus which makes proper use of the performance of the perpendicular magnetic recording medium is provided.

In one general embodiment, a perpendicular magnetic recording medium includes a crystalline seed layer having a pseudo-hcp structure with stacking faults formed above a soft magnetic underlayer, a first interlayer comprising Ru and W formed above the crystalline seed layer, a second interlayer formed above the first interlayer, and a magnetic recording layer formed above the second interlayer. The first interlayer has a W concentration between about 32 at % and about 50 at %.

In another general embodiment, a perpendicular magnetic recording medium includes a crystalline seed layer having a pseudo-hcp structure with stacking faults formed above a soft magnetic underlayer, a first interlayer comprising Ru and Mo formed above the crystalline seed layer, a second interlayer formed above the first interlayer, and a magnetic recording layer formed above the second interlayer. The first interlayer has a Mo concentration between about 36 at % and about 52 at %.

In another general embodiment, a perpendicular magnetic recording medium includes a crystalline seed layer having a pseudo-hcp structure with stacking faults formed above a soft magnetic underlayer, a first interlayer comprising Ru and Ta formed above the crystalline seed layer, a second interlayer formed above the first interlayer, and a magnetic recording layer formed above the second interlayer. The first interlayer has a Ta concentration between about 20 at % and about 30 at %.

In another general embodiment, a perpendicular magnetic recording medium includes a crystalline seed layer having a pseudo-hcp structure with stacking faults formed above a soft magnetic underlayer, a first interlayer comprising Ru and Nb formed above the crystalline seed layer, a second interlayer formed above the first interlayer, and a magnetic recording layer formed above the second interlayer. The first interlayer has a Mo concentration between about 7 at % and about 30 at %.

In yet another general embodiment, a method for forming a perpendicular magnetic recording medium includes forming a crystalline seed layer above a substrate, the crystalline seed layer comprising elements having a face-centered cubic (fcc) structure and elements having a body-centered cubic (bcc) structure, forming an interlayer above the crystalline seed layer, the interlayer comprising a second interlayer formed above a first interlayer, and forming a magnetic recording layer above the interlayer, wherein the first interlayer comprises Ru and an element selected from a group consisting of: W in a concentration between about 32 at % and about 50 at %, Mo in a concentration between about 36 at % and about 52 at %, Ta in a concentration between about 20 at % and about 30 at %, and Nb in a concentration between about 7 at % and about 30 at %.

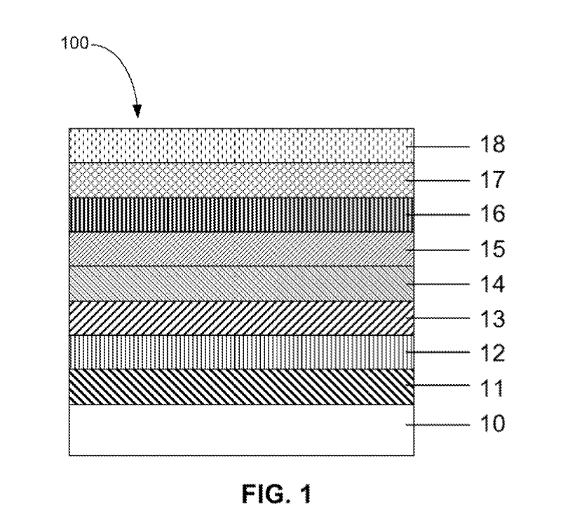

Referring now to FIG. 1, showing a cross-sectional schematic of a perpendicular magnetic recording medium 100 having a configuration in which an adhesion layer 11, a soft magnetic underlayer 12, a seed layer 13, a first interlayer 14, a second interlayer 15, a recording layer 16, and a protective layer 17 are formed in succession on a substrate 10, possibly with a liquid lubricant layer 18 formed above the protective layer 12.

It is possible to use various substrates, as would be known to one of skill in the art, for the substrate 10, including glass, aluminum alloy, plastic, silicon, etc., according to various embodiments.

The adhesion layer 11 may be chosen such that it adheres well to the substrate 10, and is preferably between about 2 nm and about 40 nm in thickness, in some embodiments. With the proviso that the adhesion layer 11 is flat, there are no particular limitations as to the material from which it may be made, and according to one embodiment, the adhesion layer 11 includes two or more materials selected from the group consisting of: Ni, Co, Al, Ti, Cr, Zr, Ta, and Nb. For example, it is possible to use TiAI, NiTa, TiCr, AlCr, NiTaZr, CoNbZr, TiAlCr, NiAlTi, CoAlTi, etc.

The soft magnetic underlayer 12 suppresses enlargement of the magnetic field generated by the magnetic head, and effectively magnetizes the recording layer 16, in one approach. No particular limitation is imposed as to the material for the soft magnetic underlayer, with the proviso that the saturated magnetic flux density (Bs) thereof is at least about 1 Tesla, uniaxial anisotropy is applied thereto in the radial direction of the disk substrate, the coercive force measured in the direction of travel of the head is no more than about 2.4 kA/m, and the soft magnetic underlayer 12 is smooth. The above characteristics may be easily obtained by using an amorphous alloy having Co or Fe as a primary component, and adding a secondary component, for example Ta, Nb, Zr, B, Cr, etc. A preferred value for the thickness of this layer varies depending on the material, and may be between about 20 nm and about 100 nm, the precise value depending upon the distance from the soft magnetic underlayer 12 to the recording layer 16, and the magnetic head with which the soft magnetic underlayer 12 is used.

The seed layer 13 enhances the hcp (00.2) crystal orientation of the interlayers 14 and 15, and the recording layer 16, in some approaches. The seed layer 13 may have a “pseudo-hcp” structure with stacking faults, including a material having an fcc structure as a primary component, in one embodiment.

“Pseudo-hcp” is a structure whereby atoms of the a plane, the b plane, and the c plane in the inherent fcc structure are stacked in the form abc, abc in the (111) direction, but part of the structure is stacked in the form ab, ab because of stacking faults, and this structure is stacked in the same way as the (001) direction of the hcp structure. In one embodiment of this structure, elements may be combined having an fcc structure with elements having a bcc structure, for example Ni and W, Pt and Cr, etc.

To achieve a pseudo-hcp structure, the compositional range of each element may be adjusted, depending on the combination of materials chosen.

In one embodiment, employing Ni and W, the W concentration may be within a range of about 5 at % to about 10 at %. In another embodiment, utilizing Pt and Cr, the Cr concentration may be set in a range of about 30 at % to about 70 at %.

In yet another embodiment containing Ni and W, corrosion resistance may be improved by replacing some Ni content with Cr and employing a NiCrW alloy.

In another embodiment containing Ni and W, lattice misfit in the seed layer 13 and interlayers 14 and 15 may be reduced by replacing some Ni content with, for example, Pt, Pd, etc., and employing a NiPtW alloy, a NiPdW alloy, etc. The seed layer 13 may have a thickness preferably between about 2 nm to about 10 nm.

In one approach, an amorphous layer, such as NiTa alloy, Ta, an alloy layer having an fcc structure, etc., may be formed under the seed layer 13 in order to enhance the crystal orientation thereof. In this case, the thickness of each layer may be chosen so that the total thickness of the seed layer 13 remains within a range of about 2 nm to about 10 nm, in one approach.

According to one embodiment, it is possible to refine the crystal grain size while maintaining the crystal orientation by adding to Ru at least one element selected from W, Mo, Ta, and Nb to first interlayer 14. Thus, the first interlayer 14 comprises an alloy whereby a second element is added to Ru. The respective added concentrations may be within the following ranges, in some embodiments (W: about 32 at %-50 at %; Mo: about 36 at %-52 at %; Ta: about 20 at %-30 at %; Nb: about 7 at % about 30 at %). These concentration ranges refer to the region where the first interlayer 14 has an hcp structure at a high temperature. A first interlayer comprising Ru may experience deterioration of hcp structure when temperature is reduced to ambient temperature, but when a first interlayer having Ru is combined with a seed layer which is pseudo-hcp, a further effect is achieved whereby the grain size is refined, which is desirable.

In yet another embodiment, the first interlayer 14 may preferably be formed under a low gas pressure, e.g., less than about 1 Pa, in order to enhance the crystal orientation and refine crystal grain size. The first interlayer 14 preferably may have a thickness in a range of about 3 nm to about 14 nm, in one embodiment.

According to one embodiment, the second interlayer 15 may be preferably comprised of Ru. This interlayer is formed in order to promote magnetic isolation of the crystal grains in the recording layer 16, and therefore it is preferably formed under a high gas pressure of about 3 Pa or more. Forming the layer under a high gas pressure and leaving a space at the grain boundary section may provide improved surface roughness and magnetic isolation of the crystal grains. The second interlayer may preferably have a thickness in a range of about 4 nm to about 14 nm, with about 6 nm to about 12 nm being even more preferred, according to some approaches.

In another embodiment, a Ru alloy including an oxide formed between the second interlayer 15 and the recording layer 16 promotes magnetic isolation of the crystal grains in the recording layer 16. To be more specific, this layer preferably has Ru and at least one oxide selected from Ti, Ta, Cr, Nb, Si; and B, and is formed under a gas pressure of at least about 3 Pa. The thickness of the layer is preferably in a range from about 0.5 nm to about 3 nm, in some embodiments. If it is thinner than about 0.5 nm, the effect of promoting the magnetic isolation of the crystal grains in the recording layer is reduced, but if it is greater than about 3 nm; there is a deterioration of the crystal orientation and an increase in the grain size distribution, which is undesirable.

According to one embodiment, the recording layer 16 may have a granular structure comprising magnetic crystal grains and a surrounding oxide, which may have Co and Pt as the main components, to which Cr, Ti, Ta, Ru, W, Mo, Cu, and B etc., may be added, in some embodiments.

In another embodiment, at least one oxide selected from Si, Ti, Ta, B, Cr, Mo, W, and Nb may be incorporated into the recording layer 16 at the non-magnetic grain boundary.

In yet another embodiment, good overwrite characteristics may be achieved by stacking a non-granular recording layer over the granular recording layer. In the current embodiment, such a recording layer has as its primary component CoCrPt, and includes at least one element selected from B, Ta, Ru, Ti, W, Mo, and Nb. Respective compositions and thicknesses may be adjusted to fit the thickness of the soft magnetic underlayer 12 and the performance of the magnetic head, and no particular limitation is imposed provided that these values lie within a range maintaining the thermal demagnetization resistance characteristics.

The protective layer 17 is preferably formed as a layer having a thickness of between about 2 nm and about 5 nm wherein carbon is a primary component, in some embodiments. For the liquid lubricant layer 18, any suitable lubricant may be used for the layer as known in the art, such as perfluoroalkyl polyether.

Experiments

The following experiments and descriptions are made for example only, and are not meant to be limiting on the invention in any way.

A perpendicular magnetic recording medium 100 having a cross-sectional structure as shown in FIG. 1 was produced using a sputtering apparatus. The base pressure prior to deposition was 2×10⁻⁵ Pa in all chambers, after which a carrier bearing the substrate was moved into each processing chamber and the processing was successively carried out. An adhesion layer 11, a soft magnetic underlayer 12, a seed layer 13, a first interlayer 14, a second interlayer 15, a recording layer 16, and a protective layer 17 were formed in succession on a substrate 10 by magnetron sputtering. Finally, a lubricant with a fluorocarbon material was applied. This lubricant may also be applied just prior to use with a magnetic head.

A glass substrate having a thickness of 0.8 mm and diameter of 65 mm was used as the substrate 10. Without heating of the substrate 10, two layers were formed under Ar gas at a pressure of 0.7 Pa, namely an adhesive layer 11 comprising Al-50 at % Ti with a thickness of 20 nm, and a soft magnetic underlayer 12 in which an Fe-34Co-10Ta-5Zr alloy film of thickness 20 nm were formed with a Ru film having a thickness of 0.5 nm interposed. An Ni-10 at % Cr-6 at % W film having a thickness of 7 nm was formed thereon as the seed layer 13. As the first interlayer 14, a film of Ru—W having a thickness of 8 nm was formed under Ar gas at a pressure of 1 Pa, after which a film of Ru having a thickness of 8 nm was formed as a second interlayer 15 under Ar gas at a pressure of 5 Pa. As the recording layer 16, a target was used in which 5 mol % SiO₂ and 5 mol % TiO₂ were added to a Co-10at % Cr-20at % alloy in order to form a film having a thickness of 6.5 nm under a pressure of 5 Pa using a gas mixture of 0.9% oxygen with Ar gas, then a target was used in which 6 mol % SiO₂ was added to a Co-22 at % Cr-14 at % Pt alloy in order to form a film having a thickness of 4.5 nm under Ar gas at a pressure of 3 Pa, and an alloy target was used comprising Co-15 at % Cr-14 at % Pt-8 at % B in order to form a film having a thickness of 3 nm under Ar gas at a pressure of 0.7 Pa. Finally, as a protective layer 17, a carbon film having a thickness of 3 nm was formed under a pressure of 0.4 Pa using a gas in which 8% nitrogen was mixed with Ar.

As the first interlayer 14, respective targets comprising Ru-32 at % W, Ru-36 at % W, Ru-40 at % W, Ru-45 at % W, and Ru-50 at % W were prepared in order to produce the media. For comparative examples 1-1 to 1-4, media were formed in which the first interlayer 14 comprised Ru, Ru-20 at % W, Ru-30 at % W, and Ru-55 at % W.

A Kerr effect magnetometer was used in order to measure the magnetic characteristics of the media. The Kerr rotation angle was detected while a magnetic field was applied in a direction perpendicular to the film surface and the Kerr loop was measured. The magnetic field was applied at a constant rate for 30 seconds from +2000 kA/m to −2000 kA/m, and then from −2000 kA/m to +2000 kA/m.

A thin-film X-ray diffraction apparatus was used in order to measure the crystal orientation and crystallite size of the media. For the crystal orientation, 2θ was obtained from the hcp (0004) diffraction peak of the recording layer measured by a θ-2θ scan, and the rocking curve was measured. The crystallite size was obtained using the diffraction profile measured by the grazing angle method in which the X-ray incident angle was fixed at a low angle.

The recording and reproduction characteristics were evaluated by spin stand testing. The evaluation was carried out using a magnetic head comprising a single pole-type recording element of track width 60 nm, and a reproduction element employing the giant magnetoresistive effect of track width 55 nm, under conditions including a circumferential speed of 10 m/s, a skew angle of 0°, and a magnetic spacing of 8 nm, approximately. The medium signal-to-noise ratio (SNR) was taken as the ratio of the reproduction output when a 10,124 fr/mm signal was recorded to the integral noise when a 70,867 fr/mm signal was recorded. The magnetic characteristics (Hc), crystal orientation (Δθ50), and medium SNR are shown in Table 1 for the media of this exemplary embodiment and of the comparative examples.

TABLE 1

| | | Hc | Δθ50 | SNR |
|---|---|---|---|---|
| | 1st Intermediate Layer | (kOe) | (degree) | (dB) |
| Ex. 1-1 | Ru—32at.%W | 5.1 | 3 | 22.5 |
| Ex. 1-2 | Ru—36at.%W | 5 | 3.1 | 22.9 |
| Ex. 1-3 | Ru—40at.%W | 4.9 | 3.1 | 23.3 |
| Ex. 1-4 | Ru—45at.%W | 4.9 | 3.1 | 23.2 |
| Ex. 1-5 | Ru—50at.%W | 4.8 | 3.2 | 22.9 |
| Comp. Ex. 1-1 | Ru | 5.2 | 3 | 21 |
| Comp. Ex. 1-2 | Ru—20at.%W | 5.2 | 3 | 21 |
| Comp. Ex. 1-3 | Ru—30at.%W | 5.2 | 3 | 21.1 |
| Comp. Ex. 1-4 | Ru—55at.%W | 4.1 | 3.9 | 19.6 |

If the media of this exemplary embodiment is compared to the comparative examples, it is clear that the medium SNR is improved while the crystal orientation is maintained when the added concentration of W is in a range between 32 at % and 50 at %. This is believed to be due to the crystal grains being refined by adding W to Ru, and the transition noise in high-density recording is reduced. In comparative examples 1-1 to 1-3, the added concentration of W was low, and the crystal orientation was good, but there was no improvement in medium SNR. It is clear that the addition of W has little to no effect if the added concentration is low. In comparative example 1-4, it is believed that the crystal orientation was poor and the medium SNR deteriorated because the added concentration of W was excessively high. For the media shown in Table I, samples were produced in which a protective layer was formed directly on the second interlayer 15, and a recording layer was not formed.

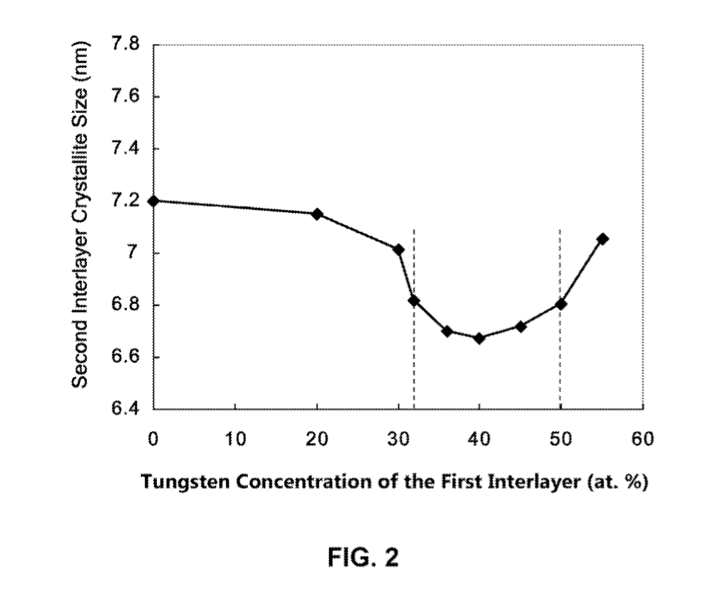

FIG. 2 shows the relationship between the crystallite size of the second interlayer measured by the grazing angle method and the added concentration of W to the first interlayer. It is clear that the crystallite size becomes smaller when the W concentration added to the first interlayer is in a range between 32 at % and 50 at %. It has been found that this range of W concentration is critical toward achieving good magnetic isolation of the crystal grains in the subsequently formed recording layer. An average crystallite size of the second interlayer of less than about 6.9 nm proved to be achievable with a first interlayer comprising an Ru-alloy with added W.

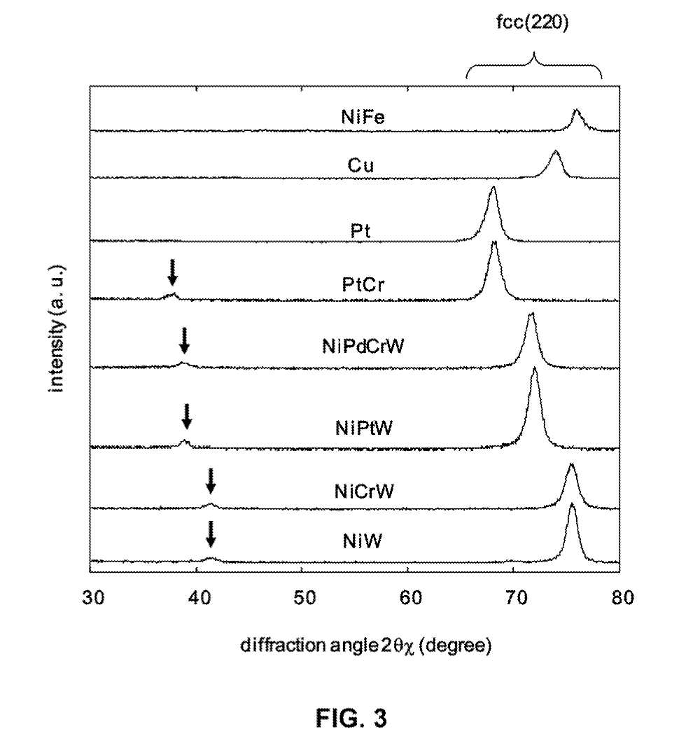

Media in which the material of the seed layer 13 was changed were produced based on the media having the structures described above. In this case, all embodiments utilized a first interlayer comprising Ru-40 at % W. The magnetic characteristics and crystal orientation are shown in Table 2. In order to confirm what kind of crystal structure these seed layers had, samples were produced in which the respective seed layers were formed at 20 nm, and interlayers and a recording layer were not formed. The diffraction profiles measured by the grazing angle method are shown in FIG. 3. In the case of the inherent fcc structure, the (110) diffraction peak cannot be seen according to the extinction rule, but a diffraction peak corresponding to (110) of the fcc structure could be confirmed in the region of 40°, as shown by the arrows for NiW, NiCrW, PtCr, NiPtW, and NiPdCrW. It can be said that these materials are pseudo-hcp materials. For Pt, Cu, and NiFe, only the (220) diffraction peak of the fcc structure was apparent, and it is clear that this was a complete fcc structure. It is clear that the media of this exemplary embodiment which employed a pseudo-hcp seed layer all had good crystal orientation. As can be seen from exemplary embodiments 1-9 and 1-10 especially, it is clear that the media in which Ni was replaced with Pt or Pd with the aim of reducing lattice misfit between the seed layer and the first interlayer showed enhanced crystal orientation. In comparative examples 1-5 to 1-7, a seed layer having an fcc structure was used, but it is believed that the crystal orientation could not be maintained because it was not pseudo-hcp. Furthermore, it is clear that when the amorphous material shown in comparative examples 1-8 to 1-10 was used for the seed layer, the crystal orientation was extremely poor. When a pseudo-hcp seed layer is used, it is believed that good crystal orientation is obtained in the RuW interlayer, due to the fact that it is a region in which RuW has an hcp structure at high temperature.

TABLE 2

| | | Hc | Δθ50 | SNR |
|---|---|---|---|---|
| | Seed Layer Composition | (kOe) | (degree) | (dB) |
| Ex. 1-6 | Ni—8at%W | 4.8 | 2.9 | 23.4 |
| Ex. 1-7 | Ni—10at%Cr—8at%W | 4.7 | 3 | 23.2 |
| Ex. 1-8 | Pt—30at%Cr | 4.6 | 3 | 22.9 |
| Ex. 1-9 | Ni—40at%Pt—6at%W | 4.5 | 2.8 | 23.5 |
| Ex. 1-10 | Ni—40at%Pd—10at% | 4.4 | 2.8 | 23.5 |
| | Cr—6at%W | | | |
| Comp. Ex. 1-5 | Pt | 4.1 | 3.8 | 19.3 |
| Comp. Ex. 1-6 | Cu | 3.6 | 4.5 | 18.7 |
| Comp. Ex. 1-7 | Ni—19at%Fe | 3.3 | 5.1 | 18.1 |
| Comp. Ex. 1-8 | Ni—37.5at%Ta | 2.6 | 5.1 | — |
| Comp. Ex. 1-9 | Ti—50at%Cr | 2.5 | 6.3 | — |
| Comp. Ex. 1-10 | Ta | 3.1 | 5.9 | — |

At this point, samples were produced in which the thickness of the seed layer 13 and the layer structure of the perpendicular magnetic recording medium were changed. Table 3 shows the magnetic characteristics (Hc) and crystal that was used. When the thickness was in the range between 2 nm and 10 nm, as in the media of the exemplary embodiments, it is clear that good crystal orientation and sufficiently small crystallite size could be achieved. As shown in comparative examples 1-11 to 1-12 where the seed layer was thinner at 1 nm, the crystal orientation was extremely poor, which is undesirable. On the other hand, when the seed layer was excessively thick as in comparative examples 1-13 to 1-14, it is clear that the crystallite size was enlarged, even when the first interlayer was RuW. Furthermore, it is clear that a seed layer in which Pt was added to NiW showed good crystal orientation even if the Pt concentration was changed, as in exemplary embodiments 1-14 to 1-15, and the crystal orientation was further improved while the crystallite size remained at a low value when NiPtW and NiCrW were stacked, as in exemplary embodiments 1-16 to 1-18.

TABLE 3

| | | | Δθ50 | Crystal- |
|---|---|---|---|---|
| | Seed Layer Composition | Hc | (de- | lite |
| | (thickness) | (kOe) | gree) | Size (nm) |
| Ex. 1-11 | Ni—10at%Cr—8at%W (2 nm) | 4.4 | 3.3 | 6.1 |
| Ex. 1-12 | Ni—10at%Cr—8at%W (5 nm) | 4.8 | 3.1 | 6.6 |
| Ex. 1-13 | Ni—10at%Cr—8at%W (10 nm) | 5.1 | 2.8 | 6.9 |
| Ex. 1-14 | Ni—20at%Pt—6at%W (7 nm) | 4.8 | 3 | 6.7 |
| Ex. 1-15 | Ni—70at%Pt—6at%W (7 nm) | 4.8 | 2.8 | 6.7 |
| Ex. 1-16 | Ni—70at%Pt—6at%W (1 nm)/ | 4.8 | 3 | 6.1 |
| | Ni—10at%Cr—8at%W (1 nm) | | | |
| Ex. 1-17 | Ni—70at%Pt—6at%W (2 nm)/ | 4.7 | 2.6 | 6.6 |
| | Ni—10at%Cr—8at%W (5 nm) | | | |
| Ex. 1-18 | Ni—70at%Pt—6at%W (5 nm)/ | 4.6 | 2.7 | 6.4 |
| | Ni—10at%Cr—8at%W (2 nm) | | | |
| Comp. | Ni—10at%Cr—8at%W (1 nm) | 3.6 | 4.5 | 6.3 |
| Ex. 1-11 | | | | |
| Comp. | Ni—8at%W (1 nm) | 3.7 | 4.4 | 6.5 |
| Ex. 1-12 | | | | |
| Comp. | Ni—10at%Cr—8at%W (12 nm) | 5.5 | 2.8 | 7.3 |
| Ex. 1-13 | | | | |
| Comp. | Ni—8at%W (12 nm) | 5.7 | 2.7 | 7.5 |
| Ex. 1-14 | | | | |

Media were prepared next in which the thickness of the first interlayer 14 was changed. In addition to the medium SNR, a 27,560 fr/mm signal was overwritten with a 4590 fr/mm signal, and the surviving component of the 27,560 fr/mm signal and the strength ratio of the 4590 fr/mm signal were obtained as the overwrite characteristics (OW). The evaluation results when the first interlayer was Ru-40 at % and the thickness was changed are shown in Table 4. As can be seen from exemplary embodiments 1-19 to 1-23, it is clear that good medium SNR and OW were obtained when the thickness of the first interlayer was in the range between 3 nm and 14 nm. As shown in comparative example 1-15, it is clear that the medium SNR deteriorated because of the poor crystal orientation when the first interlayer was less than 3 nm in thickness. Furthermore, as shown in comparative example 1-16, it is clear that the crystal orientation was good when the first interlayer was more than 14 nm in thickness, but OW was inadequate and the medium SNR was poor.

TABLE 4

| | 1st intermediate layer | Hc | Δθ50 | SNR | OW |
|---|---|---|---|---|---|
| | thickness (nm) | (kOe) | (degree) | (dB) | (dB) |
| Ex. 1-19 | 3 | 4.7 | 3.3 | 23 | 35.1 |
| Ex. 1-20 | 5 | 4.8 | 3.2 | 23.2 | 33.2 |
| Ex. 1-21 | 8 | 4.9 | 3.1 | 23.3 | 31 |
| Ex. 1-22 | 12 | 4.9 | 3 | 23.2 | 29.8 |
| Ex. 1-23 | 14 | 4.9 | 2.9 | 22.9 | 28.6 |
| Comp. Ex. 1-15 | 2 | 4.1 | 3.9 | 20.1 | 36.8 |
| Comp. Ex. 1-16 | 16 | 5.2 | 2.9 | 21.3 | 24.4 |

A glass substrate was used in this exemplary embodiment, but an aluminum alloy substrate, plastic substrate, silicon substrate, etc., may be used instead, in some embodiments. The same effect can be achieved if NiTa, TiCr, AlCr, etc., is used for the adhesion layer rather than AlTi, in some embodiments. Furthermore, the seed layer was formed directly over the soft magnetic underlayer, but the crystal orientation can be further enhanced by forming an amorphous layer such as NiTa, Ta, etc., between the two, in some embodiments. Furthermore, the recording layer was formed directly over the second interlayer, but it is possible to promote magnetic isolation of the crystal grains in the recording layer by forming a thin layer comprising a mixture of Ru and an oxide, and the noise reducing effect is particularly great when the seed layer and interlayers are thin, in some embodiments. In the same way, the recording layer was formed by stacking in succession CoCrPt—SiO₂—TiO₂, CoCrPt—SiO₂, CoCrPtB, but it is equally possible to use a granular recording layer employing different oxides, and provided that the range allows the thermal demagnetization resistance characteristics to be maintained, the effect of the present invention is achieved if another element such as Ru is added to CoCrPt, in some embodiments.

In exemplary embodiment 2, media were prepared based on media having the same structure as in exemplary embodiment 1, wherein Mo, Ta, and Nb were the elements added to the first interlayer, and the added concentrations were changed. As the comparative examples, media were prepared in which the elements added to the first interlayer were V, Cr, and Al. Table 5 shows the magnetic characteristics (Hc), crystal orientation (Δθ50) and medium SNR. The media of this exemplary embodiment all demonstrated good crystal orientation and medium SNR. In comparative examples 2-1 to 2-4, the crystal orientation was good, but the medium SNR was low. It is clear that the range in which an effect is produced varies depending on the elements added.

Furthermore, it is clear from comparing comparative examples 2-5 to 2-7 that when excessive amounts of elements are added, the crystal orientation becomes poorer and the medium SNR deteriorates. If we compare comparative examples 2-8 to 2-13, it can be seen that there is a tendency for the coercive force to increase when Cr and V are added. The crystal orientation deteriorates as the added concentrations increase, and the medium SNR is lower than in the media of the exemplary embodiment. Furthermore, if Al is added, as shown in comparative examples 2-14 to 2-16, it is clear that the coercive force drops due to the deterioration in the crystal orientation.

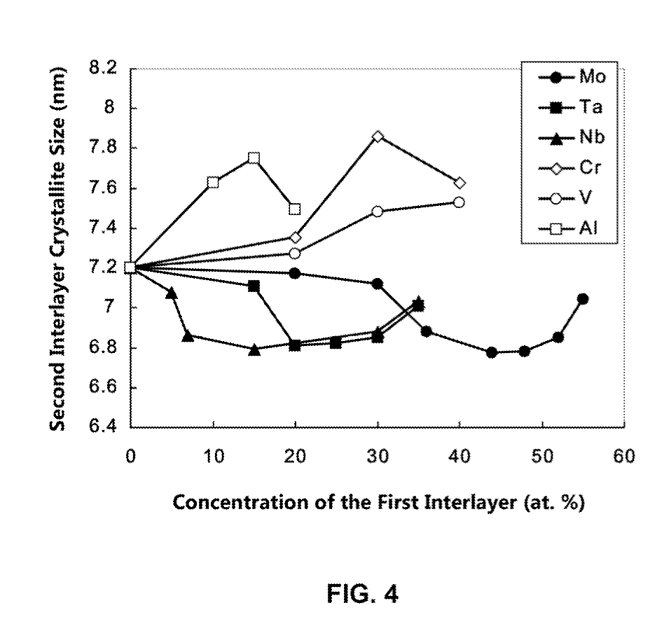

Next, for the media shown in Table 5, samples were prepared in which no recording layer was formed, and a protective layer was formed directly on the second interlayer. FIG. 4 shows the relationship between the crystallite size and the added elements in the second interlayer. The change in the crystallite size varied with the elements added to the first interlayer, and crystallite size decreased when Mo, Ta, and Nb were added, but on the other hand the crystallite size became larger when Cr, V, and Al were added. From the above, it is believed that adding elements to the first interlayer has the effect of refining the grain size because the material has a higher melting point than Ru.

It has been found that Mo in a concentration between about 36 at % and about 52 at %, Ta in a concentration between about 20 at % and about 30 at %, and Nb in a concentration between about 7 at % and about 30 at %, in addition to the previously described W range, are critical toward achieving good magnetic isolation of the crystal grains in the subsequently formed recording layer. An average crystallite size of the second interlayer of less than about 6.9 nm proved to be achievable with a first interlayer comprising an Ru-alloy with added Mo, Ta, and/or Nb.

TABLE 5

| | | Hc | Δθ50 | SNR |
|---|---|---|---|---|
| | 1st Interlayer Composition | (kOe) | (degree) | (dB) |
| Ex. 2-1 | Ru—36at%Mo | 4.9 | 3 | 22.5 |
| Ex. 2-2 | Ru—44at%Mo | 4.9 | 3.1 | 22.9 |
| Ex. 2-3 | Ru—48at%Mo | 4.8 | 3.1 | 23.3 |
| Ex. 2-4 | Ru—52at%Mo | 4.8 | 3.2 | 22.8 |
| Ex. 2-5 | Ru—20at%Ta | 4.9 | 3 | 22.9 |
| Ex. 2-6 | Ru—25at%Ta | 4.8 | 3.1 | 23.2 |
| Ex. 2-7 | Ru—30at%Ta | 4.7 | 3.2 | 22.6 |
| Ex. 2-8 | Ru—7at%Nb | 5 | 3 | 22.7 |
| Ex. 2-9 | Ru—15at%Nb | 4.8 | 3.1 | 23.1 |
| Ex. 2-10 | Ru—30at%Nb | 4.7 | 3.2 | 22.9 |
| Comp. Ex. 2-1 | Ru—20at%Mo | 5.1 | 2.9 | 21 |
| Comp. Ex. 2-2 | Ru—30at%Mo | 5 | 3 | 21.1 |
| Comp. Ex. 2-3 | Ru—15at%Ta | 4.9 | 3 | 21 |
| Comp. Ex. 2-4 | Ru—5at%Nb | 5.1 | 3 | 20.9 |
| Comp. Ex. 2-5 | Ru—55at%Mo | 4.1 | 3.8 | 20.4 |
| Comp. Ex. 2-6 | Ru—35at%Ta | 3.7 | 4.2 | 19.2 |
| Comp. Ex. 2-7 | Ru—35at%Nb | 3.6 | 4.6 | 18.4 |
| Comp. Ex. 2-8 | Ru—20at%Cr | 5.4 | 3.1 | 21.1 |
| Comp. Ex. 2-9 | Ru—30at%Cr | 5.6 | 3.3 | 21 |
| Comp. Ex. 2-10 | Ru—40at%Cr | 5.5 | 3.5 | 20.3 |
| Comp. Ex. 2-11 | Ru—20at%V | 5.3 | 3 | 20.8 |
| Comp. Ex. 2-12 | Ru—30at%V | 5.5 | 3.3 | 20.5 |
| Comp. Ex. 2-13 | Ru—40at%V | 5.4 | 3.6 | 20.1 |
| Comp. Ex. 2-14 | Ru—10at%Al | 4.4 | 3.4 | 20.2 |
| Comp. Ex. 2-15 | Ru—15at%Al | 4.2 | 3.8 | 19.7 |
| Comp. Ex. 2-16 | Ru—20at%Al | 3.8 | 4.5 | 19.1 |

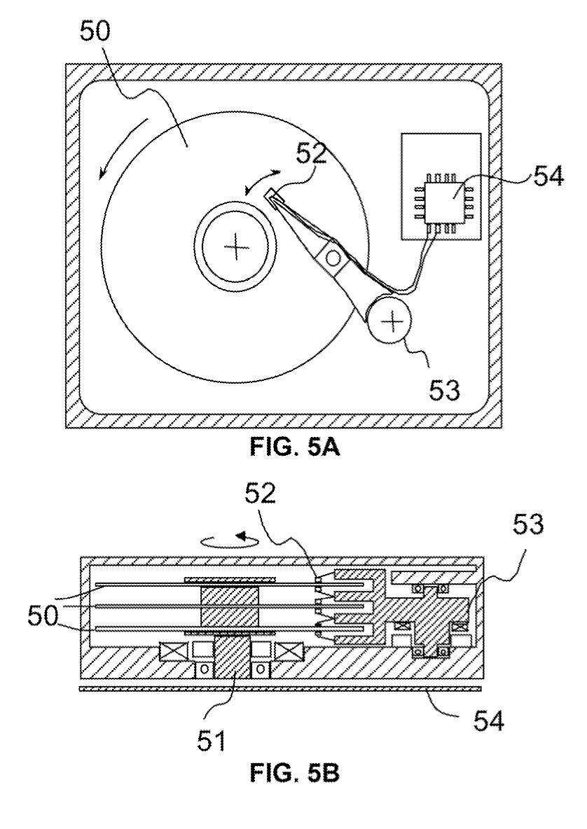

FIG. 5A is an overhead view schematic showing a magnetic storage apparatus according to one exemplary embodiment. A magnetic recording medium 50 includes the medium in the exemplary embodiments described above, and the magnetic storage apparatus includes: a drive unit (not shown), a magnetic head 52 comprising a recording section and a reproduction section, a mechanism 53 for moving the magnetic head relative to the magnetic recording medium, and a mechanism 54 for inputting/outputting signals to/from the magnetic head.

FIG. 5B is a cross-sectional schematic showing a magnetic storage apparatus according to one exemplary embodiment. A magnetic recording medium 50 includes the medium in the exemplary embodiments described above, and the magnetic storage apparatus includes: a drive unit 51, the magnetic head 52 comprising a recording section and a reproduction section, the mechanism 53 for moving the magnetic head relative to the magnetic recording medium, and a mechanism 54 for inputting/outputting signals to/from the magnetic head.

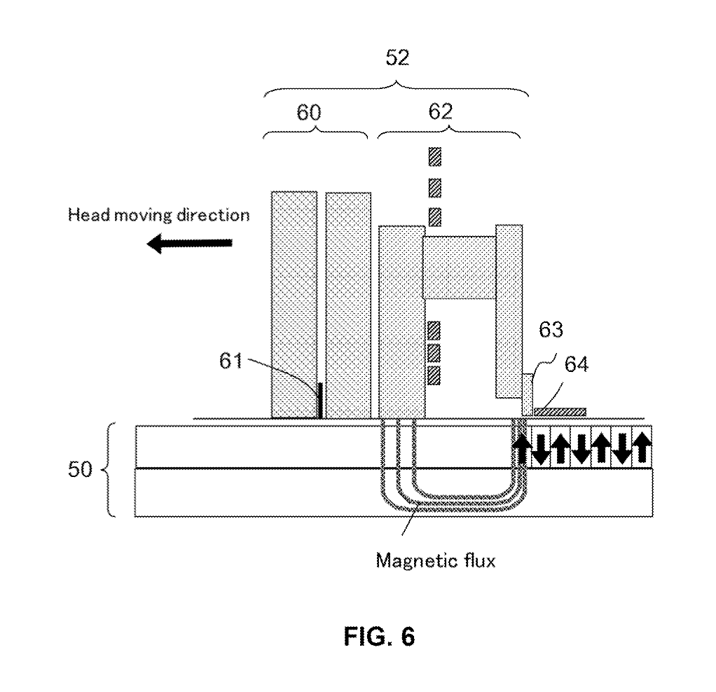

FIG. 6 shows a relationship between the magnetic head 52 and the magnetic recording medium 50. For the magnetic head 52, the amount of magnetic float thereof was set at 8 nm, a tunnel magnetoresistive effect element (TMR) was used for the reproduction element 61 in the reproduction section 60, and a wrap-around shield 64 was formed around the main pole 63 of the recording section 62. In this way, it was possible to improve the overwrite characteristics while maintaining a high medium SNR by using a magnetic head in which a shield was formed around the main pole of the recording section, and it was possible to confirm operation at 94 gigabits per square centimeter by setting the linear recording density per centimeter at 650,000 bits, and the track density per centimeter at 145,000 tracks.

It should be noted that methodology presented herein for at least some of the various embodiments may be implemented, in whole or in part, in computer hardware, software, by hand, using specialty equipment, etc. and combinations thereof.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

1. A perpendicular magnetic recording medium, comprising:
a crystalline seed layer having a face-centered cubic (fcc) structure with stacking faults formed above a soft magnetic underlayer;
a first interlayer comprising Ru and W formed above the crystalline seed layer;
a second interlayer formed above the first interlayer; and
a magnetic recording layer formed above the second interlayer,
wherein the first interlayer has a W concentration between about 32 at % and about 50 at %.

2. The perpendicular magnetic recording medium of claim 1, further comprising:
an adhesion layer formed below the soft magnetic underlayer and above a substrate; and
a protective overcoat layer formed above the magnetic recording layer.

3. The perpendicular magnetic recording medium of claim 1, wherein the crystalline seed layer has a thickness between about 2 nm and about 10 nm.

4. The perpendicular magnetic recording medium of claim 1, wherein the crystalline seed layer comprises a combination of elements having a body-centered cubic (bcc) structure and elements having an fcc structure.

5. (canceled)

6. The perpendicular magnetic recording medium of claim 1, wherein the crystalline seed layer and the first interlayer act together to create an average crystallite size of the second interlayer of less than about 6.9 nm.

7. A system, comprising:
a perpendicular magnetic recording medium as described in claim 1;
at least one magnetic head for reading from and/or writing to the magnetic recording medium;
a magnetic head slider for supporting the magnetic head; and
a control unit coupled to the magnetic head for controlling operation of the magnetic head.

8. A perpendicular magnetic recording medium, comprising:
a crystalline seed layer having a face-centered cubic (fcc) structure with stacking faults formed above a soft magnetic underlayer;
a first interlayer comprising Ru and Mo formed above the crystalline seed layer;
a second interlayer formed above the first interlayer; and
a magnetic recording layer formed above the second interlayer,
wherein the first interlayer has a Mo concentration between about 36 at % and about 52 at %.

9. (canceled)

10. (canceled)

11. The perpendicular magnetic recording medium of claim 8, wherein the crystalline seed layer and the first interlayer act together to create an average crystallite size of the second interlayer of less than about 6.9 nm.

12. A system, comprising:
a perpendicular magnetic recording medium as described in claim 8;
at least one magnetic head for reading from and/or writing to the magnetic recording medium;
a magnetic head slider for supporting the magnetic head; and
a control unit coupled to the magnetic head for controlling operation of the magnetic head.

13. A perpendicular magnetic recording medium, comprising:
a crystalline seed layer having a face-centered cubic (fcc) structure with stacking faults formed above a soft magnetic underlayer;
a first interlayer comprising Ru and Ta formed above the crystalline seed layer;
a second interlayer formed above the first interlayer; and
a magnetic recording layer formed above the second interlayer,
wherein the first interlayer has a Ta concentration between about 20 at % and about 30 at %.

14. The perpendicular magnetic recording medium of claim 13, wherein the crystalline seed layer comprises a combination of elements having a body-centered cubic (bcc) structure and elements having an fcc structure.

15. The perpendicular magnetic recording medium of claim 14, wherein the crystalline seed layer comprises Ni and at least one additional element selected from a group consisting of: Cr in a concentration between about 30 at % and about 70 at %, W in a concentration between about 5 at % and about 10 at %, Pt, and Pd.

16. The perpendicular magnetic recording medium of claim 13, wherein the crystalline seed layer and the first interlayer act together to create an average crystallite size of the second interlayer of less than about 6.9 nm.

17. A system, comprising:
a perpendicular magnetic recording medium as described in claim 13;
at least one magnetic head for reading from and/or writing to the magnetic recording medium;
a magnetic head slider for supporting the magnetic head; and
a control unit coupled to the magnetic head for controlling operation of the magnetic head.

18. (canceled)

19. (canceled)

20. (canceled)

21. (canceled)

22. (canceled)

23. A method for forming a perpendicular magnetic recording medium as recited in claim 30, the method comprising:
forming the crystalline seed layer above a substrate;
forming the first interlayer above the crystalline seed layer;
forming the second interlayer above the first interlayer; and
forming the magnetic recording layer above the interlayer.

24. The method according to claim 23, wherein the crystalline seed layer comprises elements selected from a group consisting of Ni, W, Cr, and Pt.

25. The method according to claim 23, wherein the forming the first interlayer above the crystalline seed layer is performed under a low gas pressure of less than about 1 Pa to a thickness of between about 3 nm and about 14 nm.

26. The perpendicular magnetic recording medium of claim 4, wherein the crystalline seed layer comprises Ni and W, wherein a W concentration is between about 5 at % and about 10 at %.

27. The perpendicular magnetic recording medium of claim 4, wherein the crystalline seed layer comprises Pt and Cr, wherein a Cr concentration is between about 30 at % and about 70 at %.

28. (canceled)

29. (canceled)

30. A perpendicular magnetic recording medium, comprising:
a crystalline seed layer having a face-centered cubic (fcc) structure with stacking faults formed above a soft magnetic underlayer;
a first interlayer comprising Ru and at least one element selected from a group consisting of: W in a concentration between about 32 at % and about 50 at %, Mo in a concentration between about 36 at % and about 52 at %, Ta in a concentration between about 20 at % and about 30 at %, and Nb in a concentration between about 7 at % and about 30 at %, the first interlayer being formed above the crystalline seed layer;
a second interlayer formed above the first interlayer; and
a magnetic recording layer formed above the second interlayer.

31. The perpendicular magnetic recording medium of claim 30, further comprising:
an adhesion layer formed below the soft magnetic underlayer and above a substrate; and
a protective overcoat layer formed above the magnetic recording layer.

32. The perpendicular magnetic recording medium of claim 30, wherein the crystalline seed layer has a thickness between about 2 nm and about 10 nm.

33. The perpendicular magnetic recording medium of claim 30, wherein the crystalline seed layer comprises a combination of elements having a body-centered cubic (bcc) structure and elements having an fcc structure.

34. The perpendicular magnetic recording medium of claim 33, wherein the crystalline seed layer comprises Ni and W, wherein a W concentration is between about 5 at % and about 10 at %.

35. The perpendicular magnetic recording medium of claim 33, wherein the crystalline seed layer comprises Pt and Cr, wherein a Cr concentration is between about 30 at % and about 70 at %.

36. The perpendicular magnetic recording medium of claim 30, wherein the crystalline seed layer and the first interlayer act together to create an average crystallite size of the second interlayer of less than about 6.9 nm.

37. A system, comprising:
a perpendicular magnetic recording medium as described in claim 30;
at least one magnetic head for reading from and/or writing to the magnetic recording medium;
a magnetic head slider for supporting the magnetic head; and
a control unit coupled to the Magnetic head for controlling operation of the magnetic head.
